(19) United States
(12) Patent Application Publication
(10) Pub. No.: US 2008/0165328 A1
(43) Pub. Date: Jul. 10, 2008

(54) PROJECTION APPARATUS

(75) Inventors: Chien-Chung Liao, Hsinchu (TW); Chin-Ku Liu, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: CORETRONIC CORPORATION, Hsinchu (TW)

(21) Appl. No.: 11/853,821

(22) Filed: Sep. 12, 2007

(30) Foreign Application Priority Data
Jan. 9, 2007 (TW) 96100797

(51) Int. Cl. G03B 21/14

(52) U.S. Cl. 353/94

(57) ABSTRACT

A projection apparatus including a light source set for providing a first light beam and a second light beam, a light integration rod having a light incident section and a light exit section, a light valve and a projection lens is provided. The light incident section is separated into two parts by a first axis. The first and second light beams are projected into the light integration rod in two different parts of the light incident section, and then through the light exit section to form an illumination beam. Micro mirrors are disposed on an active surface of the light valve. Each of the micro mirrors is capable of swinging about a swinging axis. The first axis projected to the active surface is coincided with a second axis which is parallel to the swinging axes and through a geometric center of the active surface.

### CROSS-REFERENCE TO RELATED APPLICATION

This application claims the priority benefit of Taiwan application serial no. 96100797, filed Jan. 9, 2007. All disclosure of the Taiwan application is incorporated herein by reference.

### BACKGROUND OF THE INVENTION

1. Field of the Invention

The present invention generally relates to a projection apparatus, more particularly, the present invention relates to a projection apparatus having a plurality of light sources.

2. Description of Related Art

With the development of technology, different kinds of projection apparatuses are widely used in various circumstances. The digital light processing projector (DLP projector) is being widely used. For improving brightness of the projection image, the DLP projector having a plurality of light sources is the general trend of the field.

Referring to FIG. 1, a conventional DLP projector 100 comprises two light sources 110a and 110b, a light integration rod 120, a focusing lens 130, a digital micro-mirror device (DMD) 140 and a projection lens 150. The light sources 110a and 110b are capable of providing a first light beam 112a and a second light beam 112b. The light integration rod 120 has a light incident section 122 and a light exit section 124 opposite to the light incident section 122. The first and the second light beams 112a and 112b are projected into the light integration rod 120 from the light incident section 122, and through the light exit section 124 to form an illumination beam 124a. The first light beam 112a is directly projected into the light integration rod 120, and the second light beam 112b is reflected by a reflection device 114 and then projected into the light integration rod 120. In addition, the focusing lens 130 and the DMD 140 are sequentially disposed on a transmission path of the illumination beam 124a, and the DMD 140 is capable of converting the illumination beam 124a into an image beam 140a. Moreover, the projection lens 150 is disposed on a transmission path of the image beam 140a for projecting the image beam 140a to a screen (not shown).

FIG. 2 is a schematic diagram illustrating positions of the first and the second light beams projected to the light incident section in FIG. 1, FIG. 3A is a schematic diagram of the DMD shown in FIG. 1. FIG. 3B is a schematic diagram illustrating a transmission of an image beam from the DMD to the projection lens. Referring to FIG. 1 to FIG. 3B, the DMD 140 has an active surface 142 and a plurality of micro mirrors 144 are disposed on the active surface 142. Each of the micro mirrors 144 is capable of swinging about a swinging axis 144a. In addition, when the first light beam 112a and the second light beam 112b are projected to the light incident section 122 of the light integration rod 120, a part of the first light beam 112a and a part of the second light beam 112b pass through a first axis 122a. The first axis 122a projected to the active surface 142 is coincided with a second axis 142a. The second axis 142a is parallel to the swinging axes 144a and through the geometric center of the active surface 142.

Referring to FIG. 2 and FIG. 3B, an area A1 of the light incident section 122 corresponds to an area B1 of the active surface 142 where the illumination beam 124a is projected to, and corresponds to an area C1 of the projection lens 150 where the image beam 140a is projected to. Since the first light beam 112a and the second light beam 112b do not pass through the area A1 of the light incident section 122 when the first light beam 112a and the second light beam 112b are projected to the light incident section 122, the light intensity of the illumination beam 124a projected to the area B1 of the active surface 142 is still weak, even after the first light beam 112a and the second light beam 112b are combined to form an illumination beam 124a by the light integration rod 120, and accordingly, the light intensity of the image beam 140a projected to the area C1 of the projection lens 150 is also weak. Moreover, referring to FIG. 1, the light incident angles are different when each light ray among the image beams 140a is projected to the projection lens, among which the largest light incident angle comes from the light ray reflected to the area C1 of the projection lens 150 from the area B1 of the active surface 142. Limiting by a light-receiving angle of the projection lens 150, if the light incident angle is too large, the brightness of an image projected on the screen may be decreased. Thus, a part of the image corresponding to the area C1 on the screen is relatively dark. In other words, the brightness uniformity of the image projected from a conventional DLP projector 110 is poor.

### SUMMARY OF THE INVENTION

The present invention is directed to a projection apparatus for improving brightness uniformity of an image.

Additional aspects and advantages of the present invention will be set forth in the description of the techniques disclosed in the present invention.

To achieve one of or all aforementioned and other advantages, the present invention provides a projection apparatus comprising a light source set, a light integration rod, a light valve and a projection lens. The light source set is capable of providing at least a first light beam and a second light beam. The light integration rod has a light incident section and a light exit section opposite to the light incident section. The light incident section is separated into two parts by a first axis. The first and the second light beams are respectively projected into the light integration rod from two different parts of the light incident section, and then through the light exit section to form an illumination beam. The light valve is disposed on a transmission path of the illumination beam for reflecting the illumination beam to form an image beam. The light valve has an active surface. A plurality of micro mirrors is disposed on the active surface, and each of the micro mirrors is capable of swinging about a swinging axis. The first axis projected to the active surface is coincided with a second axis. The second axis is parallel to the swinging axes and through a geometric center of the active surface. The projection lens is disposed on the transmission path of the image beam.

In the present invention, a first light beam and a second light beam are respectively projected to two sides of the first axis to increase the brightness of dark section in the conventional image beam. Thus, the present invention improves the brightness uniformity of an image.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a conventional digital light processing projector.

FIG. 2 is a schematic diagram illustrating positions of the first and the second light beams projected to the light incident section in FIG. 1.

FIG. 3A is a schematic diagram of the DMD shown in FIG. 1.

FIG. 3B is a schematic diagram illustrating a transmission of an image beam from a DMD to a projection lens.

FIG. 4 is a schematic diagram of a projection apparatus according to an embodiment of the present invention.

FIG. 5 is a schematic diagram illustrating positions of the first and the second light beams projected to the light incident section in FIG. 4.

FIG. 6A is a schematic diagram of the light valve in FIG. 4.

FIG. 6B is a schematic diagram illustrating a transmission of the image beam from the light valve to the projection lens.

FIG. 7 is a schematic diagram of a projection apparatus according to another embodiment of the present invention.

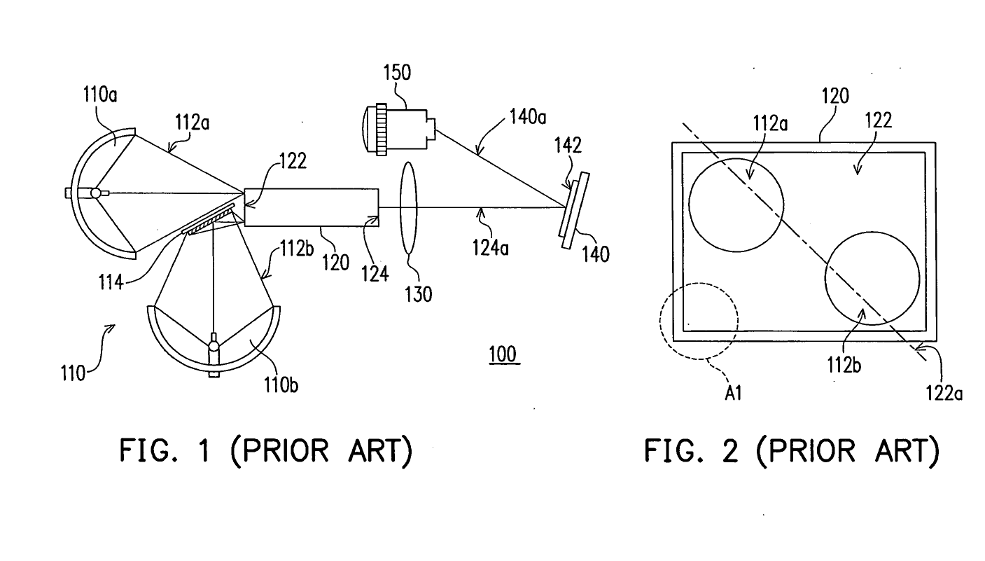

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The following embodiments accompanied with figures are representative for purposes of describing the specific embodiment. The direction terms mentioned in the present invention as up, down, forth, back, left, right etc. are only used for a direction reference of the figures, and has no intention to limit the present invention.

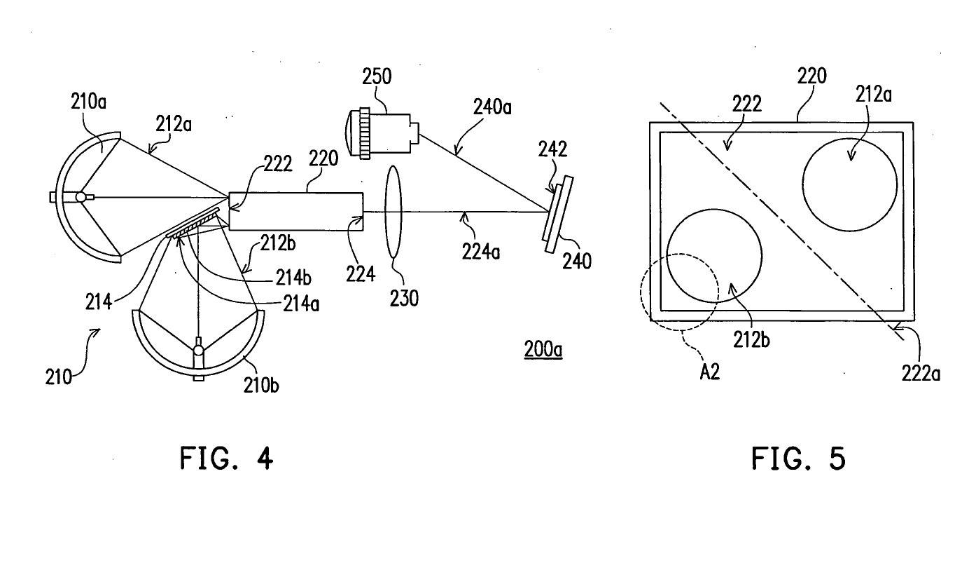

FIG. 4 is a schematic diagram of a projection apparatus according to an embodiment of the present invention, and FIG. 5 is a schematic diagram illustrating positions of the first and the second light beams projected to the light incident section in FIG. 4. Referring to FIG. 4, the projection apparatus 200a comprises a light source set 210, a light integration rod 220, a focusing lens 230, a light valve 240 and a projection lens 250. The light source set 210 is capable of providing a first light beam 212a and a second light beam 212b. In an embodiment of the present invention, the light source set 210 includes a first light source 210a, a second light source 210b and a light combiner 214. The first light source 210a is capable of providing the first light beam 212a, and the second light source 210b is capable of providing the second light beam 212b. The light combiner 214 is capable of reflecting the second light beam 212b to the light integration rod 220. In this embodiment, an optical axis of the first light source 210a is disposed perpendicular to an optical axis of the second light source 210b, the first light source 210a and the second light source 210b are respectively disposed at two sides of the light combiner 214, and the light combiner 214 is disposed on a transmission path of the second light beam 212b. The light combiner 214 is made of glass having a reflection surface 214a facing the second light source 210b. The reflection surface 214a is fabricated by coating a reflection material layer 214b on the glass. However, the light combiner 214 is not limited to glass. The light combiner 214 is also prism, lens, or other elements that can reflect light beam acknowledged by those having ordinary knowledge in the art. In another embodiment, the light combiner 214 is also disposed on the transmission path of the first light beam 212a and the second light beam 212b, the light combiner 214 comprises a glass substrate and a reflection surface 214a, and the reflection surface 214a is disposed on a part of a surface of the glass substrate and faces the second light source 210b.

Referring to FIG. 4 and FIG. 5, the light integration rod 220 has a light incident section 222 and a light exit section 224 opposite to the light incident section 222. The light source set 210 is disposed in front of the light incident section 222 of the light integration rod 220, and the light combiner 214 is disposed near the light incident section 222 of the light integration rod 220. The light incident section 222 is separated into two parts by a first axis 222a. The first light beam 212a and the second light beam 212b are respectively projected into the light integration rod 220 from two different parts of the light incident section 222, and then through the light exit section 224 to form an illumination beam 224a. In other words, the first light beam 212a and the second light beam 212b are projected into the light integration rod 220 without passing though the first axis 222a, but the first light beam 212a and the second light beam 212b are projected into the light integration rod 220 respectively from two sides of the first axis 222a. Then, the first light beam 212a and the second light beam 212b pass through the light integration rod 220, and the light integration rod 220 homogenizes the first light beam 212a and the second light beam 212b to form an illumination beam 224a.

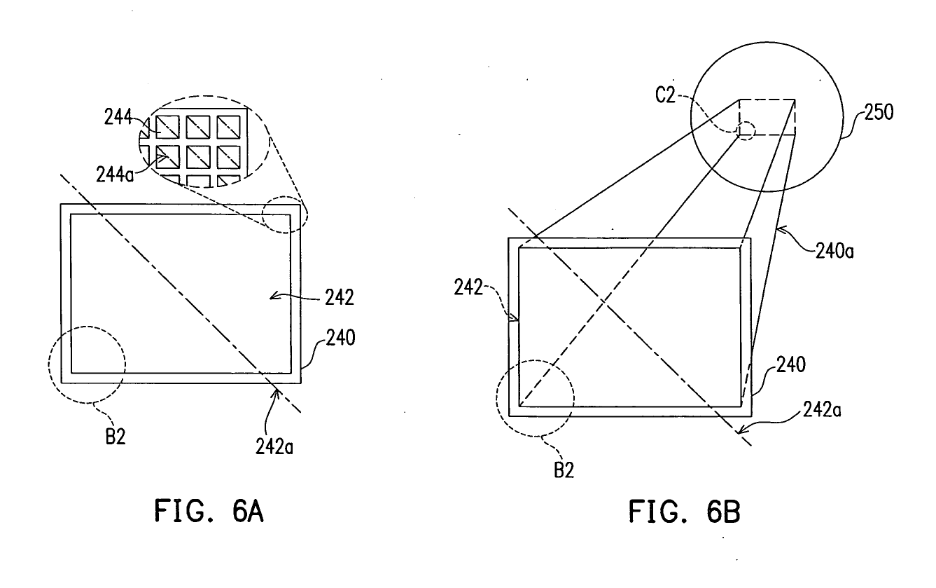

FIG. 6A is a schematic diagram of the light valve in FIG. 4, and FIG. 6B is a schematic diagram illustrating the transmission of an image beam from the light valve to the projection lens. Referring to FIG. 4 to FIG. 6B, the focusing lens 230 and the light valve 240 are sequentially disposed on a transmission path of the illumination beam 224a, and the light valve 240 is capable of reflecting the illumination beam 224a to form an image beam 240a. The projection lens 250 is disposed on a transmission path of the image beam 240a. In addition, the light valve 240 has an active surface 242, a plurality of micro mirrors 244 are disposed on the active surface 242, each of the micro mirrors 244 is capable of swinging about a swinging axis 244a. In this embodiment, the light valve 240 is a digital micro-mirror device, for example. Moreover, the first axis 222a projected to the active surface 242 is coincided with a second axis 242a. The second axis 242a is parallel to the swinging axes 244a and through a geometric center of the active surface 242.

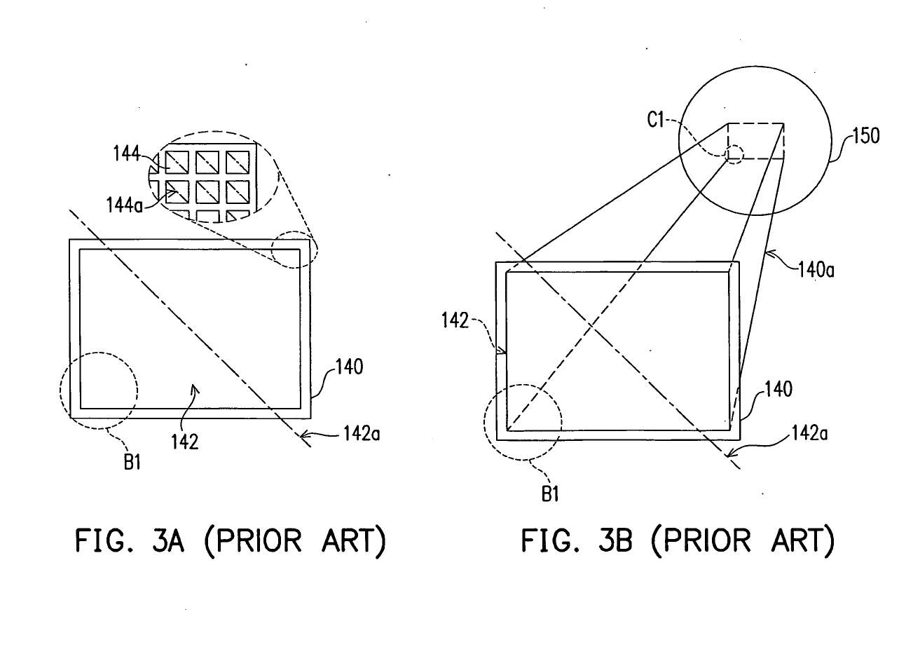

Referring to FIG. 4 to FIG. 6B, an area A2 of the light incident section 222 corresponds to an area B2 of the active surface 242 where the illumination beam 224a is projected to, and corresponds to an area C2 of the projection lens 250 where the image beam 240a is projected to. Since the second light beam 212b passes through the area A2 of the light incident section 222 when the first light beam 212a and the second light beam 212b are projected to the light incident section 222, the light intensity of the illumination beam 224a projected to the area B2 of the active surface 242 is still intensive compared to the conventional one, even after the first light beam 212a and the second light beam 212b are combined to form the illumination beam 224a by the light integration rod 220, and accordingly, the light intensity of the image beam 240a projected to the area C2 of the projection lens 250 is also intensive. Thus, even if a light incident angle of a light ray among the image beam 240a reflected to the area C2 of the projection lens 250 from the area B2 of the active surface 242 is largest, but since the light intensity of the image beam 240a projected to the area C2 of the projection lens 250 is intensive compared to the conventional one, the brightness of the image decreased due to the over-angled light incident is compensated. Thus, the situation of a part of the image corresponding to the area C1 (shown in FIG. 3B) on the screen is relatively dark due to the over-angled light incident in conventional techniques may be reduced. Therefore, the projection apparatus 200a of the present embodiment may project images with good brightness uniformity.

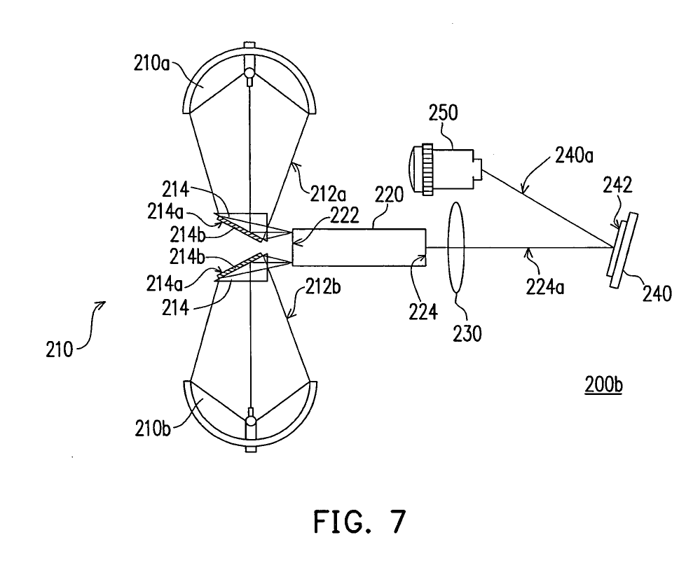

FIG. 7 is a schematic diagram of a projection apparatus according to another embodiment of the present invention. Referring to FIG. 7, the structure of the projection apparatus 200b is relatively same as that of the projection apparatus 200a shown in FIG. 4, with the exception that in the light source set 210 of the projection apparatus 200b, the first light source 210a and the second light source 210b are disposed opposite to each other, and the optical axes of the first and the second light sources 210a and 210b are parallel to each other. The light source set 210 includes two light combiners 214. The light combiners 214 are disposed in front of the light incident section 222, and the light combiners 214 are respectively disposed on the transmission path of the first light beam 212a and the second light beam 212b for reflecting the first light beam 212a and the second light beam 212b to the light integration rod 220. In this embodiment, the light combiners 214 are prisms. Each of the light combiners 214 has a reflection surface 214a, and each reflection surface 214a is the surface of the reflection material layer 214b of the light combiner 214. However, the light combiner 214 is not limited to prism. The light combiner 214 is made of glass as illustrated in FIG. 4, such as a lens, or other elements that can reflect light beam acknowledged by those having ordinary knowledge in the art. Moreover, the two light combiners 214 are integrally formed, for example.

As described above, in the present invention, the first light beam 212a and the second light beam 212b are respectively projected to two sides of the first axis 222a to improve the brightness of a part of the image beam having a too large light incident angel, when projected to the projection lens. Therefore, the projection apparatus of the present invention projects images with good brightness uniformity.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents. For example, the light source set provides two or more light beams instead of only two. In addition, any embodiment or claim of the present invention is not required to achieve all the objectives, features and advantages disclosed in the present invention. Moreover, the abstract and the title used herein are only for the purpose of assisting the search of the patent files, and are not used to limit the claims of the present invention.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection apparatus, comprising:
a light source set, for providing at least a first light beam and a second light beam;
a light integration rod, having a light incident section and a light exit section opposite to the light incident section, the light incident section being separated into two parts by a first axis, the first and the second light beams being projected into the light integration rod from two different parts of the light incident section and passing through the light exit section to form an illumination beam;
a light valve, disposed on a transmission path of the illumination beam for reflecting the illumination beam to form an image beam, the light valve having an active surface, a plurality of micro mirrors being disposed on the active surface, each of the micro mirrors being capable of swinging about a swinging axis, the first axis projected to the active surface being coincided with a second axis, and the second axis being parallel to the swinging axis and through a geometric center of the active surface; and
a projection lens, disposed on a transmission path of the image beam.

2. The projection apparatus as claimed in claim 1, wherein the light valve is a digital micro-mirror device.

3. The projection apparatus as claimed in claim 1, wherein the light source set is disposed in front of the light incident section of the light integration rod, and comprises:
a first light source, for providing the first light beam;
a second light source, for providing the second light beam; and
a light combiner, disposed near the light incident section, the light combiner being disposed on the transmission path of the second light beam for reflecting the second light beam to the light integration rod.

4. The projection apparatus as claimed in claim 3, wherein the light combiner has a reflection surface facing the second light source.

5. The projection apparatus as claimed in claim 3, wherein optical axes of the first light source and the second light source are perpendicular to each other, and the first light source and the second light source are respectively disposed at two sides of the light combiner.

6. The projection apparatus as claimed in claim 5, wherein the light combiner is disposed on the transmission path of the first light beam, and the light combiner is made of glass and has a reflection surface facing the second light source.

7. The projection apparatus as claimed in claim 1, wherein the light source set is disposed in front of the light incident section of the light integration rod, and comprises:
a first light source, for providing the first light beam;
a second light source, for providing the second light beam; and
two light combiners, disposed in front of the light incident section, the light combiners being respectively disposed on the transmission paths of the first light beam and the second light beam for reflecting the first light beam and the second light beam to the light integration rod.

8. The projection apparatus as claimed in claim 7, wherein each of the light combiners has a reflection surface.

9. The projection apparatus as claimed in claim 7, wherein the first light source and the second light source are disposed opposite to each other and optical axes of the first light source and the second light source are parallel to each other.
